(19) United States
(12) Patent Application Publication
(10) Pub. No.: US 2026/0246348 A1
(43) Pub. Date: Aug. 20, 2026

(54) SHAFT GROUNDING DEVICE, ELECTRIC MACHINE AND KIT-OF-PARTS

(71) Applicant: Schaeffler Technologies AG & Co. KG, Herzogenaurach (DE)

(72) Inventor: Christian Hartmann, Emskirchen (DE)

(73) Assignee: Schaeffler Technologies AG & Co. KG, Herzogenaurach (DE)

(21) Appl. No.: 19/160,499

(22) PCT Filed: Jan. 18, 2024
(86) PCT No.: PCT/DE2024/100044

§ 371 Date: Aug. 28, 2025

(30) Foreign Application Priority Data
Feb. 28, 2023 (DE) 10 2023 104 827.9

(51) Int. Cl. H02K 11/40; B60K 1/00

(52) U.S. Cl. CPC H02K 11/40; B60K 1/00

(57) ABSTRACT

A shaft grounding device includes a rotatably mounted shaft, first, second and third electrically conductive sleeves, an electrically conductive bridging sleeve, and an electrically conductive grounding rod. The shaft includes an end face and a hollow space projecting axially into the shaft from the end face. The first sleeve is rotationally fixed relative to the shaft and extends axially into the hollow space, and the second sleeve is arranged in or on the first sleeve. The bridging sleeve is arranged in the second sleeve, the grounding rod is arranged in and rotatable relative to the bridging sleeve, and the third sleeve is connected to the shaft in an electrically conductive manner. A first end of the grounding rod is connected to the bridging sleeve in an electrically conductive manner and a second end, of the grounding rod is connected to the third sleeve in an electrically conductive manner.

### CROSS-REFERENCE TO RELATED APPLICATIONS

This application is the United States National Phase of PCT Appln. No. PCT/DE 2024/100044 filed Jan. 18, 2024, which claims priority to German Application No. DE 102023104827.9 filed Feb. 28, 2023, the entire disclosures of which are incorporated by reference herein.

### TECHNICAL FIELD

The present disclosure relates to a shaft grounding device for dissipating an electric charge and/or voltage from a shaft, in particular for a drive train of an electrically drivable motor vehicle, including a rotatably mounted shaft into which a hollow space projects axially into the shaft starting from an end face having a shaft opening and a first electrically conductive sleeve, which is rotationally fixed with respect to the shaft, engages through the shaft opening and extends axially into the hollow space of the shaft. The disclosure also relates to an electric machine and a kit-of-parts.

### BACKGROUND

Electric machines, especially electric traction machines, are electrically charged during operation by induced shaft voltages. In addition, circulating high-frequency currents can arise in high-power motors. Such electric machines usually have a rotor and a rotor shaft, which are mounted in a housing via rolling bearings. Owing to electrical discharges or circulating high-frequency currents, rolling bearings may be damaged. To avoid this, it is necessary to dissipate this electrical energy. For example, earthing brushes or radially acting abrasive elements (carbon brushes) are known, which serve to ground the rotor shaft. Furthermore, axially acting systems for the shaft grounding device are known.

Document DE 10 2020 119 719 A1, discloses a discharge means for a motor for dissipating an electrical charge and/or voltage from a rotor via a shaft to a housing, comprising a first contact module for electrically and mechanically connecting to the shaft, a second contact module for electrically and mechanically connecting to the housing. The first and the second contact module can be rotated relative to each other and electrically connected to one another in an interior space sealed off from a housing chamber, the interior space being filled with an electrically conductive liquid, and the first contact module and the second contact module being electrically interconnected via the electrically conductive liquid.

### SUMMARY

The present disclosure provides a shaft grounding device having good mountability, improved dissipation and freedom from wear. The disclosure also provides a correspondingly improved electric machine and a kit-of-parts by means of which a simplified and conventional assembly of a shaft grounding device can be carried out.

Example embodiments broadly comprise a shaft grounding device for dissipating an electric charge and/or voltage from a shaft, in particular for a drive train of an electrically drivable motor vehicle, including a rotatably mounted shaft into which a hollow space projects axially into the shaft starting from an end face having a shaft opening and a first electrically conductive sleeve, which is rotationally fixed with respect to the shaft, engages through the shaft opening and extends axially into the hollow space of the shaft. A second electrically conductive sleeve is arranged in and/or on the first sleeve, in which in turn an electrically conductive bridging sleeve is arranged and the bridging sleeve has an electrically conductive grounding rod received therein and rotatably mounted with respect to the bridging sleeve. The grounding rod is connected in an electrically conductive manner to the bridging sleeve on one side and is connected in an electrically conductive manner to a third electrically conductive sleeve on the other side, which third electrically conductive sleeve is in turn connected to the shaft.

This makes it possible to provide an axial acting system for the shaft grounding device that functions efficiently in dry and wet electric machines and at all operating points. An existing installation space is utilized without axially or radially enlarging the electric machine. Furthermore, the shaft grounding device can also be easily integrated into existing applications at a later date. This prevents bearing damage to the rotatably mounted shaft and improves electromagnetic compatibility (EMC) in order to reduce or prevent interference with other devices.

The shaft grounding device system according to the disclosure can be constructed as an independent system and thus offered as a pre-assembled unit.

With regard to the fluids used and the structure of the shaft grounding device unit, reference is made to the applicant's pre-published DE 10 2022 113 208 A1, which is added in its entirety to the disclosure of this application by reference.

The fact that the electrically conductive sleeve is rotationally fixed with respect to the shaft means that the sleeve is firmly positioned in the circumferential direction, while the shaft can be rotated relative to the non-rotatable sleeve.

A rotor is the rotating (spinning) part of an electric machine. The rotor includes in particular a rotor shaft. The rotor shaft can be hollow, which, on the one hand, results in a weight reduction and, on the other hand, allows the supply of lubricant or coolant to the rotor body.

A rotor body for the purposes of the disclosure is therefore understood to mean the rotor without a rotor shaft. The rotor body is therefore made in particular of a rotor lamination stack and the permanent magnets inserted into the pockets of the rotor lamination stack or secured to the circumference of the rotor lamination stack, as well as any axial cover parts for closing the pockets.

The rotor may have a plurality of rotor bodies. The rotor bodies may be formed substantially of the same parts, in particular substantially identically. The rotor body may be formed from identical, in particular substantially identical rotor laminations. The rotor body may be formed from a rotor lamination stack, which is composed of a plurality of laminated individual laminations or rotor laminations, usually made of electrical steel, which is layered and stacked one above the other to form a stack, what is termed the rotor lamination stack. The individual laminations can be joined together in the rotor lamination stack by gluing, welding, or screwing. A rotor lamination stack can in particular also have permanent magnets that are inserted into the pockets of the rotor lamination stack, or that are fixed circumferentially to the rotor lamination stack. It is possible that the rotor lamination stacks are offset to each other, i.e. they are arranged at an angle to each other. This offset can be linear or V-shaped to avoid or at least reduce axial forces.

The permanent magnets to be introduced into the pockets of the laminated rotor core are understood as the rotor magnet. The permanent magnets can be inserted into the pockets of the rotor lamination stack. A single larger rotor magnet designed as a bar magnet or a plurality of smaller rotor magnets designed as permanent magnetic elements can be provided for each pocket.

A rotor lamination stack can in particular form a rotor body. A laminated rotor core is understood to mean a plurality of laminated individual laminations or rotor laminations, which are generally made from electrical metal sheet and are stacked and packaged one on top of the other to form a stack or “laminated rotor core”. The individual laminations can then be joined together in the laminated core by adhesive bonding, welding or screwing. In particular, a rotor lamination stack can also have magnetic elements inserted into the pockets of the rotor lamination stack or secured around the circumference of the rotor lamination stack as well as any axial cover parts for closing the pockets and the like.

The electric machine can in particular be designed as a rotary machine. The rotary machine can in particular be configured as a radial flow machine. In a radial flow machine, the magnetic field lines in the air gap formed between the rotor and stator extend in a radial direction. The gap between the rotor and the stator is referred to as the air gap. In a radial flow machine, this is a gap with a circular ring cross-section with a radial width that corresponds to the distance between the rotor body and the stator body.

The electric machine is intended in particular for use within a drive train of a hybrid or fully electrically driven motor vehicle. In particular, the electric machine is dimensioned such that vehicle speeds of more than 50 km/h, e.g., more than 80 km/h or more than 100 km/h can be achieved. The electric motor may have an output of more than 50 kW, e.g., more than 80 kW or more than 150 kW. Furthermore, the electric machine may provide rotational speeds greater than 8000 rpm, e.g., greater than 12,000 rpm or greater than 15,000 rpm.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

According to an example embodiment, it can be provided that the first sleeve has at least one feedthrough opening on a lateral surface, via which a fluid can be guided out of the sleeve into the hollow space. In this embodiment, the sleeve can thus provide cooling and/or lubrication of the shaft or components in the vicinity of the shaft. The first sleeve can therefore also be referred to as an oil lance.

The third sleeve may also have feedthrough openings, through which the fluid can flow, for example in an axial direction.

The shaft grounding device can be used in wet electric machines without having to provide additional installation space. For example, the small dimensions of the second sleeve mean that the oil supply to the rotor is not impeded.

According to a further development of the disclosure, it may also be provided that the shaft has, starting from the hollow space, at least one through channel extending in the radial direction through the shaft, via which the fluid can be guided out of the hollow space, whereby a hydraulic connection can be provided for cooling the rotor and/or stator of an electric machine.

Furthermore, according to an example embodiment, it can be provided that the second sleeve is fixed in the first sleeve by means of an interference fit. The first and second sleeves can be pre-assembled in a way that is favorable in terms of production technology, which can simplify subsequent assembly accordingly.

According to a further embodiment, it can be provided that the first sleeve, the second sleeve, the bridging sleeve, the third sleeve and the grounding rod are arranged coaxially to one another, which has proven to be favorable in terms of installation and particularly reliable in operation.

Furthermore, the disclosure can also be further developed in such a way that the grounding rod protrudes axially from the second sleeve and the third sleeve is arranged on the section protruding axially from the second sleeve by means of an interference fit. This embodiment provides a shaft grounding device that is particularly easy to install and reliable in operation. In principle, it would also be conceivable for the third sleeve to be non-rotatably arranged on the section protruding axially from the second sleeve by means of a positive fit, for example by means of a spline.

The present disclosure provides an electric machine, in particular for a drive train of an electrically drivable motor vehicle, including a stator and a rotor rotatable relative to the stator. The rotor is torque-transmittingly coupled to a shaft having a shaft grounding device. The shaft grounding device is designed as described above.

The first sleeve may be connected non-rotatably and in an electrically conductive manner to a motor housing, which regularly leads to good earthing of the shaft.

According to a further embodiment, it can be provided that the first sleeve is connected to a fluid circuit of the electric machine, so that a fluid can be passed through the first sleeve and the shaft and thus the rotor and/or the stator can be supplied with the fluid. This means that the shaft grounding device can also be cooled, aiding its long service life.

The present disclosure also provides a kit-of-parts for producing a shaft grounding device, in particular for a shaft grounding device of an electric machine. The kit-of-parts includes a shaft into which a hollow space extends axially into the shaft starting from an end face having a shaft opening; a first electrically conductive sleeve, which can be inserted into the hollow space; a second electrically conductive sleeve which can be arranged in and/or on the first sleeve; and a third electrically conductive sleeve which can be positioned in the hollow space and on the grounding rod in an electrically conductive manner with the shaft. An electrically conductive bridging sleeve is arranged in the second sleeve and the bridging sleeve has an electrically conductive grounding rod received therein and rotatably mounted with respect to the bridging sleeve. The grounding rod is connected in an electrically conductive manner to the bridging sleeve on one side and can be coupled in an electrically conductive manner to a third electrically conductive sleeve on the other side, which third electrically conductive sleeve is can in turn be coupled to the shaft.

This allows the components necessary for producing the shaft grounding device to be made available in a particularly convenient manner. The kit-of-parts can, for example, be a packaging unit. Furthermore, it is possible to design the kit-of-parts as a compilation of separate storage containers for storing the individual components or the respective component groups of the kit-of-parts.

### BRIEF DESCRIPTION OF THE DRAWINGS

The present disclosure is explained in more detail below with reference to figures without limiting the general concept of the disclosure.

In the figures:

FIG. 1 shows a motor vehicle having an electric drive train in a schematic block diagram view,

FIG. 2 shows an electric machine with a shaft grounding device in a schematic axial sectional view,

FIG. 3 shows a detailed representation of a shaft having a shaft grounding device in an axial sectional view,

FIG. 4 shows an axial sectional representation of a shaft grounding device in an exploded view, and

FIG. 5 shows a kit-of-parts for producing a shaft grounding device in a schematic representation.

### DETAILED DESCRIPTION

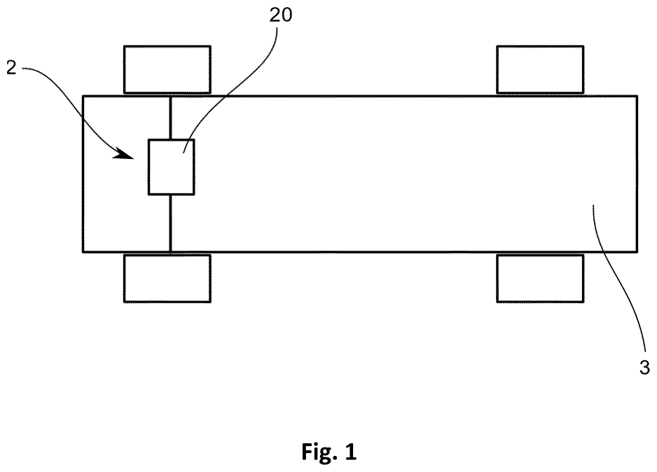

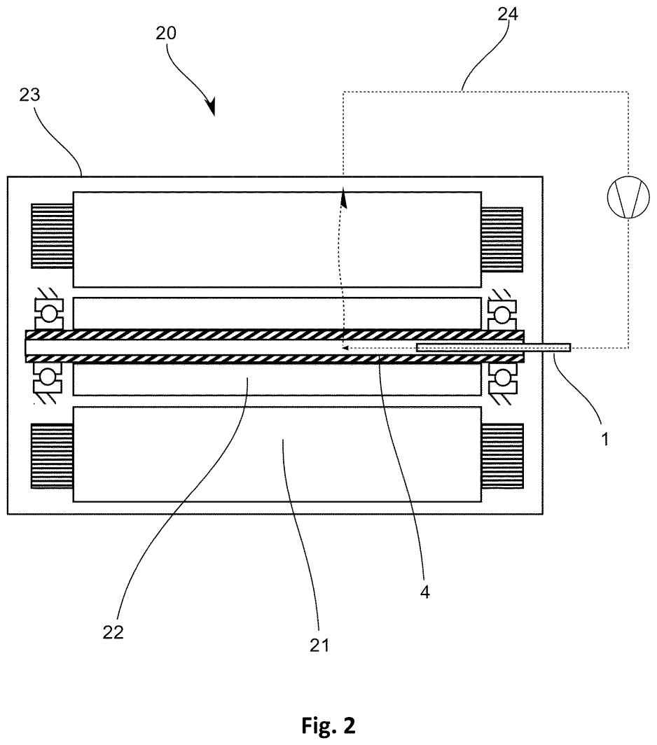

FIG. 1 shows an electric machine 20 in a drive train 2 of an electrically drivable motor vehicle 3. The electric machine 20—which is shown in FIG. 2—includes a stator 21 and a rotor 22 rotatable relative to the stator 21, and the rotor 22 is torque-transmittingly coupled to a shaft 4 having a shaft grounding device 1.

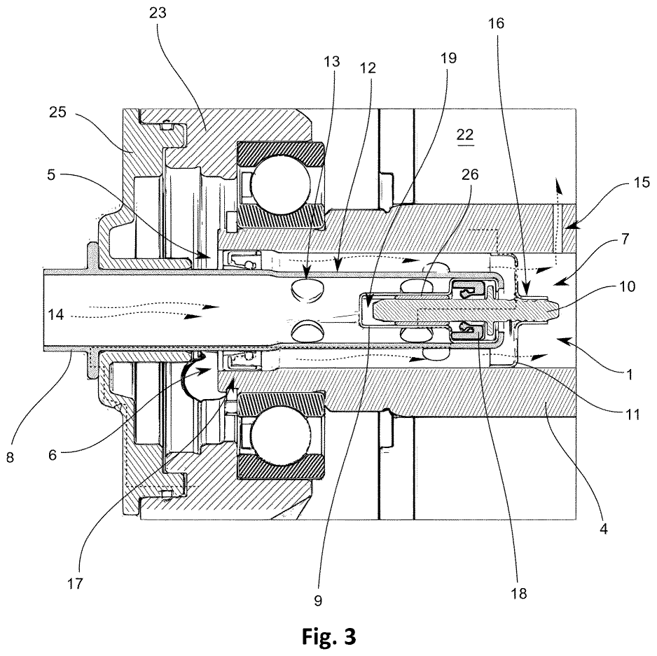

FIG. 3 shows a detailed view of the shaft grounding device 1 for dissipating an electric charge and/or voltage. The shaft grounding device has a rotatably mounted shaft 4, into which a hollow space 7 extends axially into the shaft 4 starting from an end face 6 having a shaft opening 5. A first sleeve 8, which is electrically conductive and non-rotatable with respect to the shaft 4, engages through the shaft opening 5 and extends axially into the hollow space 7 of the shaft 4. The electrically conductive sleeve 8 is therefore non-rotatable with respect to the shaft 4. The sleeve 8 is therefore fixed in the circumferential direction, while the shaft 4 can be rotated relative to the non-rotatable sleeve 8. The first sleeve 8 is connected to a motor housing 23 in an electrically conductive and non-rotatable manner via a housing cover 25. The shaft 4 is mounted in the motor housing 23 via roller bearings (not further specified).

From the synopsis of FIG. 1 with FIG. 2, it can be seen that the first sleeve 8 is connected to a fluid circuit 24 of the electric machine 20, so that a fluid 14 can be passed through the first sleeve 8 and the shaft 4 and thus the rotor 22 and/or the stator 21 can be supplied with the fluid 14.

A second electrically conductive hollow cylindrical sleeve 9 is arranged in the first hollow cylindrical sleeve 8, in which an electrically conductive bridging sleeve 26 is arranged, which has an electrically conductive grounding rod 10 received therein and rotatably mounted relative to the bridging sleeve 26. This grounding rod 10 is connected in an electrically conductive manner to the bridging sleeve 26 on one hand and to a third electrically conductive sleeve 11 on the other. The third hollow cylindrical sleeve 11 is in turn connected to the shaft 4.

In the exemplary embodiment shown, the second sleeve 9 is fixed in the first sleeve 8 by means of an interference fit. The first sleeve 8, the second sleeve 9, the bridging sleeve 26, the third sleeve 11 and the grounding rod 10 are arranged coaxially to each other. The grounding rod 10 protrudes axially from the second sleeve 9 Section 16 of the third sleeve 11, protruding axially from the second sleeve 9, is non-rotatably arranged on the grounding rod by means of an interference fit. In principle, it would also be conceivable for the third sleeve 11 to be non-rotatably arranged on the section 16 protruding axially from the second sleeve by means of a positive fit, for example by means of a spline.

The first sleeve 8 has at least one feedthrough opening 13 on a lateral surface 12, via which a fluid 14 can be guided out of the sleeve 8 into the hollow space 7. The shaft 4 in turn has, starting from the hollow space 7, at least one through channel 15 extending in a radial direction through the shaft 4, via which the fluid 14 can be guided out of the hollow space 7. In the embodiment shown, the first sleeve 8 thus functions as an oil lance. This is sealed off from the surroundings by the seal 17 in the first sleeve 8.

For electrical contacting, the interior of the second sleeve 9 is filled with an electrically conductive liquid 19. The grounding rod 10 and the second sleeve 9 are in electrically conductive contact with one another through the electrically conductive liquid 19 and a sleeve 26 arranged coaxially between the grounding rod 10 and the second sleeve 9. For example, the electrically conductive liquid is designed as an electrically conductive oil, grease, liquid metal or ionic liquid. Due to the structure described below, it is also possible to use oils and greases without special conductive components. The second sleeve 9 is separated from the first sleeve 8 or an environment of the shaft grounding device 1 in a fluid-tight manner so that the electrically conductive liquid 19 cannot exit the second sleeve 9. This results in an axially insertable and effective shaft grounding device 1, which can be used in both dry and wet environments. Since the electrical contact between the second sleeve 9 and the grounding rod 10 is established through the electrically conductive liquid 19 and the sleeve 26 arranged coaxially between the grounding rod 10 and the second sleeve 9, the shaft grounding device 1 operates with low friction and without wear during operation of the electric machine 20, so that conductive abrasion is unlikely. Furthermore, the electrically conductive liquid 19 enables operation regardless of the position, as the electrically conductive liquid 19 ensures contact between the bridging sleeve 26 and the grounding rod 10.

In an example embodiment, the annular gap has a simple annular gap width, i.e. a distance between the inner circumference of the bridging sleeve 26 and the outer circumference of the grounding rod 10 of less than 200 um, e.g., less than 60 um or less than 30 um.

The small annular gap width increases the electrical conductivity and/or reduces the electrical resistance of the shaft grounding device 1.

The electrically conductive liquid—the fluid 14—itself may be electrically conductive and/or mixed with electrically conductive additives. In principle, the electrically conductive liquid can be formed as a liquid metal or an ionic liquid or the like. However, the electrically conductive liquid may be in the form of a conductive oil or grease. Although conductive oils and greases generally have a lower conductivity than, for example, liquid metal, they are less toxic and/or easier to handle. Use of the bridging sleeve 26 compensates for the lower conductivity, so the bridging sleeve 26 enables technically reasonable use of conductive oils and/or greases. In particular, an electrically conductive liquid with an electrical conductivity at 25° C. of more than 10,000 nS/m, e.g., more than 30,000 nS/m, is used, such as oils or greases with conductive additives or other oil-free and/or fat-free liquids. These are particularly suitable for low-impedance applications.

For lower transmission resistance requirements, i.e. for higher transmission resistances, even standard gear oils can be used with the bridging sleeve.

In an alternative embodiment, the electrically conductive liquid then has an electrical conductivity at 25° C. of less than 500 nS/m, e.g., less than 300 nS/m, less than 100 nS/m or less than 50 nS/m. On the other hand, the electrical conductivity may be greater than 1 nS/m, e.g., greater than 5 nS/m or greater than 10 nS/m. This electrical conductivity makes it possible to use transmission oils as they are commonly used, so specially adapted liquids, especially those with conductive additives, can be dispensed with. This is made possible by the use of the bridging sleeve 26 and the resulting reduced annular gap width.

The current path through the shaft grounding device 1 is indicated by the dashed line in FIG. 3.

The grounding rod 10 is designed as a metallic, in particular electrically conductive, cylindrical rod, which is inserted into the second sleeve 9 in the axial direction to such an extent that the grounding rod 10 is partly immersed in the electrically conductive liquid 19 in the axial area of the second sleeve 9. An electrical path is thus established between the grounding rod 10 and the second sleeve 9 via the electrically conductive liquid 19, the bridging sleeve 26 and the second sleeve 9. The induced currents are safely dissipated to earth via this path of least resistance so that the currents are diverted away from the bearing through this system. The bearings of the connected assemblies, such as the transmission, etc., can also be protected in this way. The shaft grounding device 1 has a seal 18, and the grounding rod 10 is guided in a sealing manner into the second sleeve 9 via the seal 18. The grounding rod 10 is positioned above the seal 18 in a radial direction, sealing against the second sleeve 9.

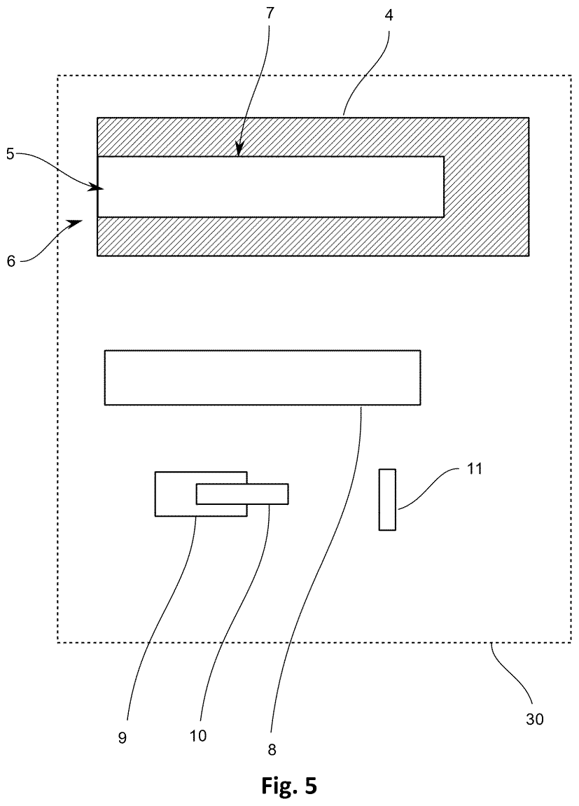

For assembly, a kit-of-parts 30 can be provided for producing the shaft grounding device 1, as shown in FIG. 5.

The kit-of-parts 30 includes a shaft 4 into which a hollow space 7 extends axially into the shaft 4 starting from an end face 6 having a shaft opening 5. Furthermore, the kit-of-parts 30 has a first electrically conductive sleeve 8, which can be inserted into the hollow space 7, and a second electrically conductive sleeve 9, which can be arranged in and/or on the first sleeve 8. The second sleeve 9 has an electrically conductive grounding rod 10 received therein and rotatably mounted relative to the second sleeve 9, and the grounding rod 10 is electrically conductively connected to the second sleeve 9.

An electrically conductive bridging sleeve 26 is arranged in the second sleeve 9, which is designed to be rotatable relative to the electrically conductive grounding rod 10.

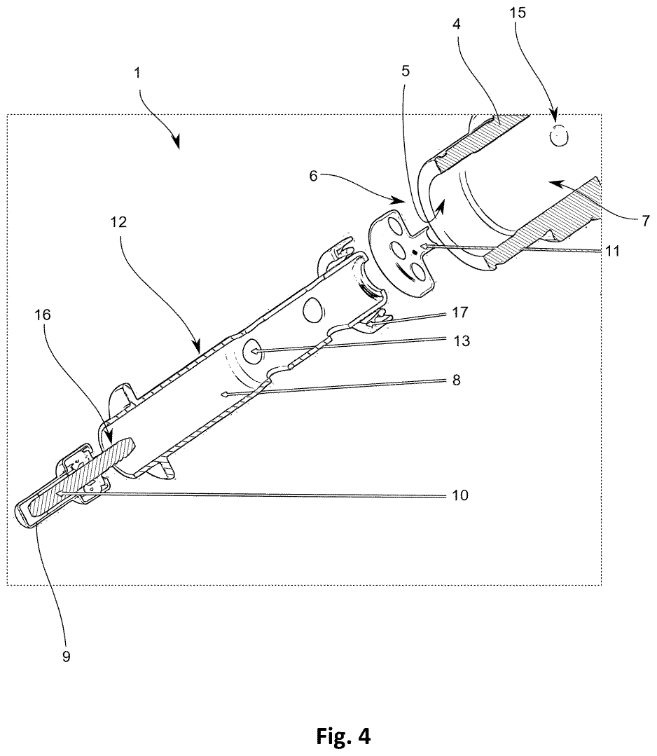

Furthermore, the kit-of-parts 30 has a third electrically conductive sleeve 11 which can be positioned in an electrically conductive manner in the hollow space 7 and on the grounding rod 10. This can also be understood well on the basis of FIG. 4.

The present disclosure is not limited to the embodiments shown in the figures. The above description is therefore not to be regarded as limiting, but rather as illustrative. A stated feature may be present in at least one embodiment, but does not exclude the presence of further features. Where the claims and the above description define “first” and “second” features, this designation serves to distinguish between two features of the same type without defining an order of precedence.

### REFERENCE NUMRALS

1 Shaft grounding device
2 Drive train
3 Motor vehicle
4 Shaft
5 Shaft opening
6 End face
7 Hollow space
8 First sleeve
9 Second sleeve
10 Grounding rod
11 Third sleeve
12 Lateral surface
13 Feedthrough opening
14 Fluid
15 Through channel
16 Section
17 Seal
18 Seal
19 Liquid
20 Machine
21 Stator
22 Rotor
23 Motor housing
24 Fluid circuit
25 Housing cover
26 Bridging sleeve
30 Kit-of-parts

1. A shaft grounding device for dissipating an electric charge or voltage from a shaft, in particular for a drive train of an electrically drivable motor vehicle, comprising a rotatably mounted shaft into which a hollow space projects axially into the shaft starting from an end face having a shaft opening and a first electrically conductive sleeve, which is rotationally fixed with respect to the shaft, engages through the shaft opening and extends axially into the hollow space of the shaft,
wherein:
in or on the first sleeve a second electrically conductive sleeve is arranged, in which in turn an electrically conductive bridging sleeve is arranged and the bridging sleeve has an electrically conductive grounding rod received therein and rotatably mounted with respect to the bridging sleeve, wherein the grounding rod is connected in an electrically conductive manner to the bridging sleeve on one side and is connected in an electrically conductive manner to a third electrically conductive sleeve on the other side, which third electrically conductive sleeve is in tum connected to the shaft.

2. The shaft grounding device according to claim 1, wherein:
the first sleeve has at least one feedthrough opening on a lateral surface, via which a fluid can be guided out of the sleeve into the hollow space.

3. The shaft grounding device according to claim 1, wherein:
the shaft has, starting from the hollow space, at least one through channel extending in the radial direction through the shaft, via which the fluid can be guided out of the hollow space.

4. The shaft grounding device according to claim 1,
wherein:
the second sleeve is fixed in the first sleeve by means of an interference fit.

5. The shaft grounding device according to one of the preceding claim 1,
wherein:
the first sleeve, the second sleeve, the bridging sleeve, the third sleeve and the grounding rod are arranged coaxially to each other.

6. The shaft grounding device according to one of the claim 1, wherein:
the grounding rod protrudes axially from the second sleeve and the third sleeve is non-rotatably arranged on the section protruding axially from the second sleeve by means of an interference fit or a form fit.

7. An electric machine, in particular for a drive train of an electrically drivable motor vehicle, comprising a stator and a rotor rotatable relative to the stator, wherein the rotor is torque-transmittingly coupled to a shaft having a shaft grounding device,
wherein:
the shaft grounding device is designed according to claim 1.

8. The electric machine according to claim 7,
wherein:
the first sleeve is connected non-rotatably and in an electrically conductive manner to a motor housing.

9. The electric machine according to claim 7, wherein:
the first sleeve is connected to a fluid circuit of the electric machine, so that a fluid can be passed through the first sleeve and the shaft and thus the rotor or the stator can be supplied with the fluid.

10. A kit-of-parts for producing a shaft grounding device, in particular for a shaft grounding device of an electric machine, comprising
a shaft into which a hollow space extends axially into the shaft starting from an end face having a shaft opening,
a first electrically conductive sleeve, which can be inserted into the hollow space,
a second electrically conductive sleeve which can be arranged in or on the first sleeve, wherein an electrically conductive bridging sleeve is arranged in the second sleeve and the bridging sleeve has an electrically conductive grounding rod received therein and rotatably mounted with respect to the bridging sleeve, wherein the grounding rod is connected in an electrically conductive manner to the bridging sleeve on one side and can be coupled in an electrically conductive manner to a third electrically conductive sleeve on the other side, which third electrically conductive sleeve can in turn be coupled to the shaft, and
a third electrically conductive sleeve which can be positioned in the hollow space and on the grounding rod in an electrically conductive manner with the shaft.

11. A shaft grounding device, comprising:
a rotatably mounted shaft, comprising:
an end face; and
a hollow space projecting axially into the rotatably mounted shaft from the end face;
a first electrically conductive sleeve, rotationally fixed relative to the rotatably mounted shaft and extending axially into the hollow space;
a second electrically conductive sleeve arranged in or on the first electrically conductive sleeve;
an electrically conductive bridging sleeve arranged in the second electrically conductive sleeve;
an electrically conductive grounding rod arranged in and rotatable relative to the electrically conductive bridging sleeve; and
a third electrically conductive sleeve connected to the rotatably mounted shaft in an electrically conductive manner, wherein a first end of the electrically conductive grounding rod is connected to the electrically conductive bridging sleeve in an electrically conductive manner and a second end, opposite the first end, of the electrically conductive grounding rod is connected to the third electrically conductive sleeve in an electrically conductive manner.

12. The shaft grounding device of claim 11, wherein the first electrically conductive sleeve comprises a lateral surface with a feedthrough opening arranged for guiding a fluid out of the first electrically conductive sleeve into the hollow space.

13. The shaft grounding device of claim 12, wherein the rotatably mounted shaft comprises a through channel starting from the hollow space and extending radially through the rotatably mounted shaft that is arranged for guiding the fluid out of the hollow space.

14. The shaft grounding device of claim 11, wherein the second electrically conductive sleeve is fixed in the first electrically conductive sleeve by an interference fit.

15. The shaft grounding device of claim 11, wherein the first electrically conductive sleeve, the second electrically conductive sleeve, the electrically conductive bridging sleeve, the third electrically conductive sleeve and the electrically conductive grounding rod are arranged coaxially to one another.

16. The shaft grounding device of claim 11, wherein the second end of the electrically conductive grounding rod protrudes axially from the second electrically conductive sleeve and is non-rotatably connected to the third electrically conductive sleeve by an interference fit.

17. An electric machine for a drive train of an electrically drivable motor vehicle, comprising:
the shaft grounding device of claim 11;
a stator; and
a rotor, rotatable relative to the stator and torque-transmittingly coupled to the rotatably mounted shaft.

18. The electric machine of claim 17, further comprising a motor housing, wherein the first electrically conductive sleeve is connected non-rotatably and in an electrically conductive manner to the motor housing.

19. The electric machine of claim 17, further comprising a fluid circuit, wherein the first electrically conductive sleeve is connected to the fluid circuit such that a fluid passes through the first electrically conductive sleeve and the rotatably mounted shaft to supply the rotor or the stator with the fluid.
